(19) United States
(12) Patent Application Publication
(10) Pub. No.: US 2019/0064848 A1
(43) Pub. Date: Feb. 28, 2019

(54) METHOD FOR CONTROLLING A GROUP OF VEHICLES

(71) Applicant: Robert Bosch GmbH, Stuttgart (DE)

(72) Inventors: Volker Hofsaess, Moeglingen (DE); Christian Wegend, Ditzingen (DE); Martin Rous, Mundelsheim (DE)

(21) Appl. No.: 16/106,432

(22) Filed: Aug. 21, 2018

(30) Foreign Application Priority Data
Aug. 23, 2017 (DE) 102017214784.9

(51) Int. Cl. G05D 1/02; G08G 1/00; G08G 1/127; G08G 1/16; H04W 4/44

(52) U.S. Cl. CPC G05D 1/0293; G08G 1/22; G05D 1/0297; G05D 2201/0213; G08G 1/164; G05D 1/0289; H04W 4/44; G08G 1/127

(57) ABSTRACT

A method for controlling a group of vehicles, the group of vehicles including at least two vehicles. The method includes transmitting a piece of driving information from at least one of the vehicles to a vehicle-independent processing unit; ascertaining individual control rules for the individual vehicles of the group of vehicles as a function of the transmitted piece of driving information; transmitting the ascertained individual control rules back to the respective vehicles; and controlling each vehicle of the group of vehicles as a function of the transmitted piece of driving information, using the individual control rule for the respective vehicle, with the aid of the vehicle-independent processing unit.

### CROSS REFERENCE

The present application claims the benefit under 35 U.S.C. § 119 of German Patent Application No. DE 102017214784.9 filed on Aug. 23, 2017, which is expressly incorporated herein by reference in its entirety.

### FIELD

The present invention relates to a method for controlling a group of vehicles and to a computer program and a machine-readable storage medium on which the computer program is stored. The present invention also relates to a processing unit.

### BACKGROUND INFORMATION

In conventional methods for controlling a group of vehicles made up of commercial vehicles driving in succession, the distances between the individual commercial vehicles of the group of vehicles are decreased to approximately ten to fifteen meters, so that the fuel consumption and the vehicle emissions of the group of vehicles are reduced as a result of a reduction in the aerodynamic drag.

A method for controlling multiple vehicles in order to operate the multiple vehicles in a convoy is described in German Patent No. DE 10 2010 013 647 A1, distances being determined based on the respective actual positions of each of the multiple vehicles in order to operate the multiple vehicles in the convoy, and a respective ordered vehicle position having a respective global position determination coordinate being selected for each of the multiple vehicles based on the determined distances.

### SUMMARY

An example embodiment of the present invention provides a method for controlling a group of vehicles, the group of vehicles including at least two vehicles, and the method including the following steps:
transmitting a piece of driving information from at least one of the vehicles to a vehicle-independent processing unit;
ascertaining individual control rules for the individual vehicles of the group of vehicles as a function of the transmitted piece of driving information;
transmitting the ascertained individual control rules back to the respective vehicles; and
controlling each vehicle of the group of vehicles as a function of the transmitted piece of driving information, using the individual control rule for the respective vehicle, with the aid of the vehicle-independent processing unit.

The present invention furthermore includes a processing unit for carrying out the method, a computer program, and a machine-readable memory medium.

A group of vehicles within the scope of the present invention may be understood to mean a group of at least two vehicles. The group of vehicles may be a vehicle convoy or a group of vehicles, for example. It is possible that the group of vehicles is a formation of vehicles driving in succession. This means, in other words, the vehicles of the group of vehicles are not mechanically connected. The vehicles of the group of vehicles may use shared route planning to maintain the formation among the vehicles of the group of vehicles. The vehicles of the group of vehicles may drive at a very small spatial distance from one another to reduce a consumption of fuel as a result of the reduced aerodynamic drag of the vehicles in the group of vehicles. The vehicles of the group of vehicles may be suitable for an autonomous operation, in particular for autonomous driving. The vehicles are driven in a semi-automated, highly automated or fully automated manner. In particular, the vehicles are controlled with the aid of a vehicle-independent processing unit. It is advantageous when the vehicles of the group of vehicles are trucks and/or passenger cars. The number of the vehicles participating in the group of vehicles may change. This means, in other words, that additional vehicles may participate in the group of vehicles or vehicles may leave the group of vehicles.

The vehicles of the group of vehicles each include at least one transmission unit. The transmission unit is designed to transmit a piece of driving information from the vehicle to a vehicle-independent processing unit. The transmission unit may be designed to transmit the piece of driving information with the aid of a radio signal. For example, the transmission unit may be a radio set. The piece of driving information may be transmitted continuously, at defined intervals or periodically with the aid of the transmission unit. It is possible that the piece of driving information is transmitted at a frequency in the range of 0.1 hertz to 100 hertz. The piece of driving information may alternatively be transmitted only or additionally when a hazardous situation occurs. It is also possible that the vehicles of the group of vehicles transmit pieces of driving information to the vehicle-independent processing unit at the beginning of the participation in the group of vehicles. The vehicles of the group of vehicles each include at least one receiving unit. The receiving unit is designed to receive a control signal from the vehicle-independent processing unit. The receiving unit is designed to receive the control signal with the aid of a radio signal. The receiving unit is designed to transmit the control signal to a control unit of the vehicle situated on the vehicle in order to control the vehicle. For example, the receiving unit may be a radio receiver. It is also possible that the receiving unit, together with the transmission unit, is a communication unit or a radio module. The receiving unit and the transmission unit may be part of the control unit situated on the vehicle. The transmission unit is furthermore designed to transmit a confirmation signal to the vehicle-independent processing unit and/or to the receiving units of the other vehicles of the group of vehicles.

Within the scope of the present invention, a vehicle-independent processing unit may be understood to mean a processing unit which is not attached to a vehicle. Within the scope of the present invention, the vehicle-independent or vehicle-unattached processing unit may be a processing unit which is situated away from or outside the vehicles of the group of vehicles. The vehicle-independent processing unit may be a data processing system, which is designed to receive pieces of information from a vehicle and to transmit control signals to a vehicle. For example, the vehicle-independent processing unit may be a stationary server unit or a cloud computing system. The vehicle-independent processing unit is designed to ascertain individual control rules for the individual vehicles of the group of vehicles as a function of the transmitted piece of driving information. Within the scope of the present invention, an individual control rule may be understood to mean a rule for controlling a vehicle, which is designed in a deliberate and defined manner for the respective vehicle. It is possible that the individual control rule takes pieces of driving state information, pieces of vehicle information, pieces of driver information or pieces of driving route information about the respective vehicle into consideration. By way of example, in the case of a transmitted piece of driving information about the distance from the respective preceding vehicle, a value for the deceleration of the respective vehicle may be individually established during an emergency brake application of the group of vehicles in such a way that the vehicles of the group of vehicles are prevented from rear ending one another. Accordingly, the individual control rules for the different vehicles of the group of vehicles may differ. The vehicle-independent processing unit is designed to transmit the ascertained control rules back to the respective vehicles.

Within the scope of the present invention, a piece of driving information may be understood to mean a piece of information with the aid of which the control of a group of vehicles may be implemented or improved.

Advantageously, the piece of driving information is a piece of driving state information and/or a piece of vehicle information and/or a piece of driver information and/or a piece of driving route information of a vehicle of the group of vehicles.

Within the scope of the present invention, a piece of driver information may be understood to mean a piece of information about a driver of the vehicle. For example, the piece of driver information may be a piece of information about a driving period or a rest period of the driver, a planned switch of the driver or a medical condition of the driver.

Within the scope of the present invention, a piece of vehicle information may be understood to mean a piece of information about a vehicle. For example, the piece of vehicle information may be a size, a type, an engine power or a drag coefficient of the vehicle, a braking power, an equipment with driver assistance systems, a towing capacity or a mass of a load of the vehicle, a piece of information about transported goods, in particular dangerous goods, a total volume or a filled volume of a fuel tank, or a due date of a vehicle inspection. The piece of vehicle information may also be a piece of performance information about safety-relevant systems, such as a time duration of a pressure buildup of a braking unit. It is also possible that the piece of vehicle information is a piece of information about damage on the vehicle.

Within the scope of the present invention, a piece of driving state information may be understood to mean a piece of information about a driving state of a vehicle. The driving state may depend on the vehicle itself, the control of the vehicle and/or surroundings of the vehicle. The piece of driving state information may be an instantaneous speed, acceleration, deceleration, an instantaneous operating state of a driver assistance system, an instantaneous steering angle or an instantaneous distance from a following or preceding vehicle.

Within the scope of the present invention, a piece of driving route information may be a piece of information about a scheduled driving route, a defined destination, a traffic situation, in particular a piece of congestion information, or about a parking facility. Furthermore, the pieces of driving route information may also be pieces of weather information or pieces of weather condition information.

It is advantageous when the piece of driving state information is a piece of information about an implemented or a provided change of a driving state of a vehicle of the group of vehicles. For example, the implemented or provided change of the driving state may be a braking process or an acceleration process of the vehicle, a change in a distance from a preceding or following vehicle, a steering movement or an operating state of a driver assistance system.

The method according to the present invention makes it possible to control a group of vehicles essentially in real time. This is made possible, in particular, by a vehicle-independent processing unit since, in principle, arbitrarily large processing and memory capacities may be made available for an evaluation of the transmitted piece of driving information and an ascertainment of the control of the group of vehicles. In this way, it is possible to calculate essentially in real time how every vehicle of the group of vehicles optimally reacts to suddenly occurring disturbances, such as an obstacle. Thereafter it is possible, with the aid of the vehicle-independent processing unit, to simultaneously control all vehicles of the group of vehicles, regardless of the number of vehicles participating in the group of vehicles, using an individual control rule for the respective vehicle, whereby, for example, synchronous emergency braking or a synchronous evasive maneuver may be implemented with a minimal reaction time of the vehicles. This embodiment also allows vehicles between which no direct communication is possible, for example due to differing interfaces or communication protocols, to form a group of vehicles.

It is advantageous when the control of a vehicle of the group of vehicles includes an activation of an acceleration unit and/or a braking unit and/or a steering unit of the respective vehicle. The acceleration unit is designed to accelerate the vehicle. For example, the acceleration unit may be a motor drive, in particular an internal combustion engine or an electric motor. The braking unit is designed to decelerate the vehicle. For example, the braking unit may be a pneumatic or hydraulic braking system. The steering unit is designed to laterally drive or steer the vehicle. For example, the steering unit may be a rack and pinion steering or a ball and nut steering. This embodiment allows the movements of the vehicles to be matched.

Furthermore, it is advantageous when the method provides a step of confirming a receipt of the back-transmitted individual control rules by the respective vehicle, a confirmation signal being transmitted by the respective vehicle to the vehicle-independent processing unit and/or to at least one further vehicle of the group of vehicles for confirmation. The confirmation signal may be a radio signal. For example, the confirmation signal may be transmitted with the aid of the transmission unit situated on the respective vehicle. It is possible that the control of the vehicles of the group of vehicles takes place only when all vehicles of the group of vehicles have confirmed the receipt of the back-transmitted individual control rules. It is also possible that one or multiple confirmation signal(s) is/are transmitted to the transmission unit and/or the other vehicles during the control of the vehicle of the group of vehicles. This embodiment allows safety risks in the event of incomplete or disrupted signal transmission to be reduced.

It is advantageous when the piece of vehicle information is a fill level of a fuel tank of the vehicle and/or the piece of driver information is a driving period or rest period of a driver of the vehicle. It is possible that a location and/or a point in time for a joint filling of the fuel tank or for a joint observation of the rest periods is/are ascertained with the aid of the vehicle-independent processing unit. This embodiment allows the group of vehicles to be operated particularly economically.

It is also advantageous when the piece of driving state information is an operating state of a driver assistance system of a vehicle. The driver assistance system may, for example, be an element from the following list of driver assistance systems: trailer stability program, anti-lock braking system (ABS), traction control system (TCS), autonomous emergency braking system (AEBS), adaptive cruise control, electronic brake assistance system (EBA), electronic stability program (ESP), lane detection system. The operating state of the driver assistance system may, for example, be one of multiple operating stages of the autonomous emergency braking system: If a first vehicle of the group of vehicles identifies a hazard to the group of vehicles, a piece of information about the identification of the hazard is transmitted from the first vehicle to the vehicle-independent processing unit. If, upon identification of the hazard, a brake pad of the first vehicle is automatically applied against a brake disk of the first vehicle (“electronic brake prefill”), a piece of information about the application of the brake pad against the brake disk is transmitted from the first vehicle to the vehicle-independent processing unit. It is also possible that a piece of information about initiated measures, such as a tightening of seat belts for protecting persons in the first vehicle, is transmitted from the first vehicle to the vehicle-independent processing unit. It is, in particular, advantageous when the implemented or provided change of the driving state of a vehicle of the group of vehicles is a braking process, in particular an emergency braking process, of a vehicle or a maneuver to avoid an object or a change of the traffic lane. For example, the braking process may be initiated by a driver assistance system of the vehicle. The piece of information about the braking process is transmitted from the vehicle of the group of vehicles carrying out the braking process to the vehicle-independent processing unit. This embodiment allows a risk of a rear-end collision, in particular within the group of vehicles or in the group of vehicles, to be identified in a timely manner.

The object may, for example, be a further vehicle, which due to its trajectory represents a hazard for the group of vehicles. It is possible that the object is a slowly driving or stationary vehicle, for example due to a technical malfunction, an accident or a traffic congestion, or a vehicle intersecting a trajectory of the group of vehicles. It is also possible that the object is a two-wheeler, a pedestrian or an animal. It is advantageous when the object is identified by a first vehicle of the group of vehicles preceding the further vehicle of the group of vehicles. The change of the traffic lane may, for example, be a beginning or an end of a passing maneuver. The vehicle changing the driving state or changing the traffic lane may transmit a piece of information about a steering angle of the vehicle, about an operating state of a turn signal of the vehicle or about an instantaneous trajectory of the vehicle to the vehicle-independent processing unit. This embodiment allows an optimal adaptation of the driving state of the vehicle of the group of vehicles as individual control rules in response to the avoidance of the object or the change of the traffic lane of a vehicle of the group of vehicles to be ascertained very quickly with the aid of the vehicle-independent processing unit.

It is furthermore advantageous when the provided change of the driving state of a vehicle of the group of vehicles is an intended withdrawal of the vehicle from the group of vehicles. It is possible, for example, that a withdrawal of the vehicle from the group of vehicles at an exit ramp or a highway junction is intended. A piece of information about the intended withdrawal of the vehicle may be transmitted from the vehicle to the vehicle-independent processing unit. This embodiment allows an adaptation of the distances and of the speed to be predefined for the group of vehicles, in particular the vehicles directly preceding and following the withdrawing vehicle, in such a way that the withdrawing vehicle is able to leave the group of vehicles at the intended point in time and without jeopardizing other road users.

It is particularly advantageous when, in the step of controlling the group of vehicles, one of the variables of distance between the vehicles, speed of the vehicles, steering angles of the vehicles and/or an operating state of a driver assistance system and/or a defined driving route of the vehicles and/or a change of these variables is predefined by the vehicle-independent processing unit.

It is possible that the vehicle-independent processing unit predefines an increase in the distances between the vehicles of the group of vehicles, for example, upon identifying a hazard to the group of vehicles, during an intended withdrawal of a vehicle from the group of vehicles, during a change of the traffic lane or a maneuver to avoid an object. Furthermore, the distance between the vehicles remaining in the group of vehicles may be reduced again after the withdrawal of the vehicle. Moreover, an increase in the distances between the vehicles of the group of vehicles may be predefined when a temperature of an engine of a vehicle rises to ensure sufficient supply of a ventilation system of the engine with fresh air.

It is also possible that the vehicle-independent processing unit predefines a decrease in the speed of the vehicles of the group of vehicles, for example, upon identifying a hazard to the group of vehicles, during an emergency brake application of a vehicle of the group of vehicles, a maneuver to avoid an object or during an intended withdrawal of a vehicle from the group of vehicles. During an emergency brake application of a first vehicle of the group of vehicles, a deceleration of the vehicles of the group of vehicles following the first vehicle may be predefined in such a way that the deceleration of the following vehicles is greater than the deceleration of the first vehicle to prevent the vehicles from rear ending one another. As an alternative, an increase in the speed of the vehicles of the group of vehicles may be predefined during a passing maneuver, for example.

It is furthermore possible that the vehicle-independent processing unit predefines a steering angle of the vehicles of the group of vehicles, for example during a change of the traffic lane or a maneuver to avoid an object. It is furthermore possible that the vehicle-independent processing unit predefines an operating state of the driver assistance systems of the vehicles of the group of vehicles, for example, upon identifying a hazard to the group of vehicles, during an intended withdrawal of a vehicle from the group of vehicles, during a change of the traffic lane or a maneuver to avoid an object. The vehicle-independent processing unit, for example, may predefine an activation of the autonomous emergency braking system, of the trailer stability program or of the electronic stability program.

It is also possible that the vehicle-independent processing unit predefines a change in the driving route or an interruption of the trip of the vehicles of the group of vehicles at a fuel supply station, in particular a gas station, or on a parking lot, for example when a driving period of a driver of a vehicle of the group of vehicles is about to be exceeded or in the event of a low fill level of a fuel tank of a vehicle of the group of vehicles. The vehicle-independent processing unit may also predefine a change in the driving route of the group of vehicles in the event of a repair of a vehicle or maintenance or an inspection.

When the described variables for a control of the group of vehicles are predefined, the vehicle-independent processing unit may additionally take a load, a stopping distance, an equipment with driver assistance systems or a destination of the individual vehicles of the group of vehicles into consideration.

Advantageously, at least the instantaneous distances of the vehicles from one another, the instantaneous trajectory and the engine power, braking power, drag coefficient and the load of the vehicles are transmitted from the vehicles to the vehicle-independent processing unit. As a function of these and further above-described variables, the vehicle-independent processing unit may ascertain distances between the vehicles and an overall speed of the group of vehicles in such a way that a fuel consumption of the group of vehicles is preferably low and, at the same time, the distances between the vehicles are large enough to ensure a safe braking process or a safe evasive maneuver. This embodiment allows the group of vehicles to be controlled as a function of the transmitted pieces of driving information with the aid of the individual control rules in such a way that the locomotion in a group of vehicles or a transportation of goods with the group of vehicles is particularly economical and safe.

It is particularly advantageous when the piece of vehicle information is a fill level of a fuel tank of the vehicle and/or the piece of driver information is a driving period or rest period of a driver of the vehicle, and a change or an adaptation of the driving route is predefined for the vehicles of the group of vehicles as a function of the piece of vehicle information. In this way, the group of vehicles may be operated particularly efficiently.

It is also particularly advantageous when the implemented or provided change of the driving state of a vehicle of the group of vehicles is a braking process, in particular an emergency braking process, of a vehicle, and the initiation of a braking process is predefined for at least the vehicles of the group of vehicles following the braking vehicle. This may considerably reduce the risk of collisions or rear-end collisions.

Furthermore, it is particularly advantageous when the provided change of the driving state of a vehicle of the group of vehicles is an intended withdrawal of the vehicle from the group of vehicles, and an increase in the distances between the withdrawing vehicle and the vehicles remaining in the group of vehicles is predefined for the group of vehicles. The withdrawing vehicle may thus safely leave the group of vehicles.

Moreover, it is particularly advantageous when the implemented or provided change of the driving state is a maneuver to avoid an object or a change of the traffic lane, and a steering angle, an increase in the distances and/or an adaptation of the speed are predefined for the group of vehicles. In this way, collisions with the object may be prevented, or a passing maneuver of the entire group of vehicles may be carried out.

This method may preferably be implemented in a computer program which is stored on a machine-readable memory medium. This memory medium may be installed in a processing unit, for example, so that the processing unit may carry out the method.

### BRIEF DESCRIPTION OF THE DRAWINGS

The present invention is described in greater detail hereafter by way of example based on the figures.

FIG. 1 shows a schematic illustration of a first exemplary embodiment of the processing unit.

FIG. 2 shows a flow chart of a method for controlling a group of vehicles.

### DETAILED DESCRIPTION OF EXAMPLE EMBODIMENTS

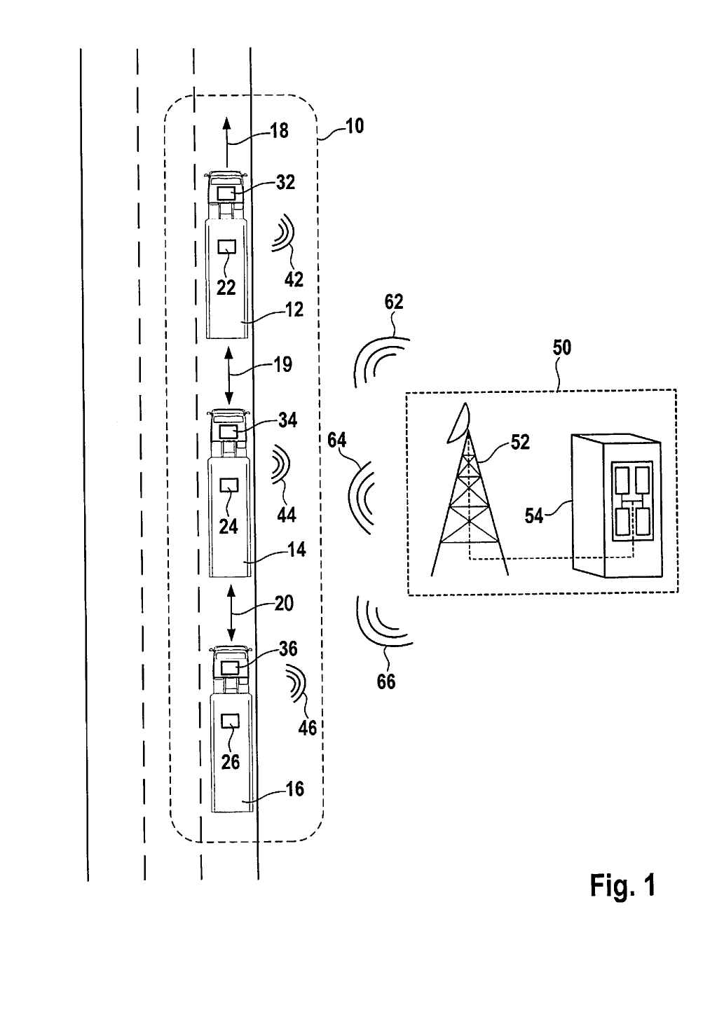

FIG. 1 shows a schematic representation of a group of vehicles and a vehicle-independent processing unit.

Group of vehicles 10 includes three trucks 12, 14, 16. Trucks 12 14, 16 are driving successively in same driving direction 18. Second truck 14 follows first truck 12 at a defined distance 19. Furthermore, third truck follows second truck at a defined distance 20.

Trucks 12, 14, 16 each include a communication unit 22, 24, 26 and a control unit 32, 34, 36. Communication units 22, 24, 26 transmit pieces of driving information from trucks 12, 14, 16 with the aid of radio signals 42, 44, 46 to vehicle-independent processing unit 50.

In this exemplary embodiment, a piece of information about the initiation of an emergency braking process is transmitted from first truck 12 to vehicle-independent processing unit 50. In addition, a piece of information about the speeds of trucks 12, 14, 16 and distances 19, 20 at the point of time of the transmission are transmitted from trucks 12, 14, 16 to vehicle-independent processing unit 50.

Vehicle-independent processing unit 50 includes a communication unit 52 and a processing unit 54. Processing unit 54 is a server 54.

Communication unit 52 is designed to receive radio signals 42, 44, 46 from trucks 12, 14, 16 and to transmit these to processing unit 54. Processing unit 54 is designed to ascertain individual control rules for an advantageous control of trucks 12, 14, 16 as a function of the pieces of driving information transmitted with the aid of radio signals 42, 44, 46.

In this exemplary embodiment, a deceleration of trucks 12, 14, 16 is ascertained as a function of the transmitted speeds and distances 19, 20 of trucks 12, 14, 16 with the aid of processing unit 54. The deceleration is ascertained in such a way that three trucks 12, 14, 16 carry out an emergency braking process, whereby a collision of trucks 12, 14, 16 is prevented. This means that, taking the speeds and the distances of trucks 12, 14, 16 into consideration, the decelerations for trucks 12, 14, 16 ascertained by processing unit 54 as individual control rules may be different in scope. Processing unit 54 is designed to transmit the ascertained decelerations to communication unit 52.

Communication unit 52 is designed to transmit the ascertained decelerations with the aid of radio signals 62, 64, 66 to trucks 12, 14, 16. Communication units 22, 24, 26 of trucks 12, 14, 16 are designed to receive radio signals 62, 64, 66 and to transmit the ascertained decelerations to control units 32, 34, 36 of trucks 12, 14, 16 in order to control trucks 12, 14, 16. Vehicle-independent processing unit 50 is thus designed to control group of vehicles 10 as a function of the transmitted pieces of driving information.

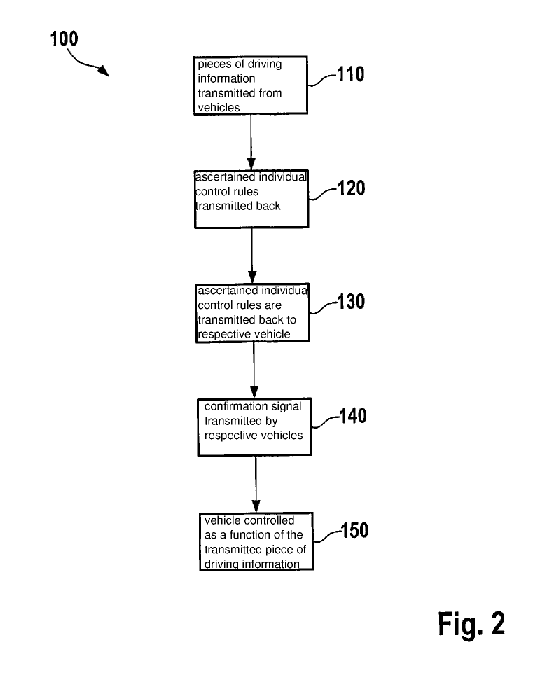

FIG. 2 shows a flow chart of a method for controlling group of vehicles 10. The method is denoted as a whole by reference numeral 100.

In step 110, pieces of driving information are transmitted from vehicles 12, 14, 16 of group of vehicles 10 to vehicle-independent processing unit 50.

Step 110 includes the transmission of a first piece of driving information from first vehicle 12 of group of vehicles 10 to vehicle-independent processing unit 50, the transmission of a second piece of driving information from second vehicle 14 of group of vehicles 10 to vehicle-independent processing unit 50, and the transmission of a third piece of driving information from third vehicle 16 of group of vehicles 10 to vehicle-independent processing unit 50. It is possible that the pieces of driving information are transmitted simultaneously to vehicle-independent processing unit 50.

In step 120, the pieces of driving information transmitted to vehicle-independent processing unit 50 are processed with the aid of vehicle-independent processing unit 50. Individual control rules for individual vehicles 12, 14, 16 of group of vehicles 10 are ascertained as a function of the transmitted pieces of driving information.

In step 130, the ascertained individual control rules are transmitted back to respective vehicles 12, 14, 16 of group of vehicles 10. Step 130 includes the transmission of a first control signal to first vehicle 12 of group of vehicles 10, the transmission of a second control signal to second vehicle 14 of group of vehicles 10, and the transmission of a third control signal to third vehicle 16 of group of vehicles 10, to control vehicles 12, 14, 16 using the individual control rule for respective vehicle 12, 14, 16.

In step 140, a confirmation signal is transmitted by respective vehicle 12, 14, 16 to vehicle-independent processing unit 50 in order to confirm the receipt of the back-transmitted individual control rules.

In step 150, group of vehicles 10 is controlled as a function of the transmitted piece of driving information, using the individual control rule for respective vehicle 12, 14, 16, with the aid of vehicle-independent processing unit 50. Control signals are transmitted from vehicle-independent processing unit 50 to vehicles 12, 14, 16 of group of vehicles 10 to control group of vehicles 10 with the aid of vehicle-independent processing unit 50.

What is claimed is:

1. A method for controlling a group of vehicles, the group of vehicles including at least two vehicles, the method comprising:
transmitting a piece of driving information from at least one of the vehicles to a vehicle-independent processing unit;
ascertaining individual control rules for the individual vehicles of the group of vehicles as a function of the transmitted piece of driving information;
transmitting the ascertained individual control rules back to the respective vehicles; and
controlling each vehicle of the group of vehicles as a function of the transmitted piece of driving information, using the individual control rule for the respective vehicle, with the aid of the vehicle-independent processing unit.

2. The method as recited in claim 1, wherein the control of a vehicle of the group of vehicles includes an activation of at least one of: (i) an acceleration unit, (ii) a braking unit, and/or (iii) a steering unit, of the respective vehicles.

3. The method as recited in claim 1, further comprising:
confirming a receipt of the back-transmitted individual control rules by the respective vehicle, a confirmation signal being transmitted from the respective vehicle to at least one of: (i) the vehicle-independent processing unit, and/or (ii) at least one further vehicle of the group of vehicles, for confirmation.

4. The method as recited in claim 1, wherein the piece of driving information is at least one of: (i) a piece of driving state information, (ii) a piece of vehicle information, (iii) a piece of driver information, and/or (iv) a piece of driving route information of a vehicle of the group of vehicles.

5. The method as recited in claim 4, wherein at least one of: (i) the piece of vehicle information is a fill level of a fuel tank of the vehicle, and/or (ii) the piece of driver information is a driving period or rest period of a driver of the vehicle.

6. The method as recited in claim 4, wherein the piece of driving state information is an operating state of a driver assistance system of a vehicle.

7. The method as recited in claim 4, wherein the piece of driving state information is a piece of information about an implemented or a provided change of a driving state of a vehicle of the group of vehicles.

8. The method as recited in claim 7, wherein the implemented or provided change of the driving state of a vehicle of the group of vehicles is an emergency braking process of a vehicle or a maneuver to avoid an object or a change of the traffic lane.

9. The method as recited in claim 7, wherein the provided change of the driving state of a vehicle of the group of vehicles is an intended withdrawal of the vehicle from the group of vehicles.

10. The method as recited in claim 1, wherein, in the step of controlling the group of vehicles, one of the variables of distance between the vehicles, speed of the vehicles, steering angles of the vehicles, and/or an operating state of a driver assistance system and/or a defined driving route of the vehicles and/or a change of these variables is predefined by the vehicle-independent processing unit.

11. The method as recited in claim 1, wherein the vehicles of the group of vehicles are trucks and/or passenger cars.

12. A non-transitory machine-readable memory medium on which is stored a computer program for controlling a group of vehicles, the group of vehicles including at least two vehicles, the computer program, when executed by a processing unit, causing the processing unit to perform:
transmitting a piece of driving information from at least one of the vehicles to a vehicle-independent processing unit;
ascertaining individual control rules for the individual vehicles of the group of vehicles as a function of the transmitted piece of driving information;
transmitting the ascertained individual control rules back to the respective vehicles; and
controlling each vehicle of the group of vehicles as a function of the transmitted piece of driving information, using the individual control rule for the respective vehicle, with the aid of the vehicle-independent processing unit.

13. A processing unit, which is configured to control a group of vehicles, the group of vehicles including at least two vehicles, the processing unit configured to:
transmitting a piece of driving information from at least one of the vehicles to a vehicle-independent processing unit;
ascertaining individual control rules for the individual vehicles of the group of vehicles as a function of the transmitted piece of driving information;
transmitting the ascertained individual control rules back to the respective vehicles; and
controlling each vehicle of the group of vehicles as a function of the transmitted piece of driving information, using the individual control rule for the respective vehicle, with the aid of the vehicle-independent processing unit.
